(19) United States
(12) Patent Application Publication
(10) Pub. No.: US 2018/0227599 A1
(43) Pub. Date: Aug. 9, 2018

(54) Entertainment Center Technical Configuration and System and Method for Use of Same

(71) Applicant: Enseo, Inc., Richardson, TX (US)

(72) Inventors: William C. Fang, Plano, TX (US); Vanessa Ogle, Fairview, TX (US)

(21) Appl. No.: 15/893,389

(22) Filed: Feb. 9, 2018

Related U.S. Application Data
(63) Continuation-in-part of application No. 15/887,833, filed on Feb. 2, 2018.
(60) Provisional application No. 62/458,892, filed on Feb. 14, 2017.
(60) Provisional application No. 62/455,819, filed on Feb. 7, 2017.

(51) Int. Cl. H04N 21/214; H04N 21/442; H04N 21/4425; H04N 21/4363; H04N 21/81; G06T 17/05; G06T 19/00; H04N 21/414

(52) U.S. Cl. CPC H04N 21/2143; H04N 21/44227; H04N 21/4425; H04N 21/43637; G06T 2219/004; G06T 17/05; G06T 19/00; H04N 21/414; H04N 21/8146

(57) ABSTRACT

An entertainment center technical configuration and system and method for use of the same are disclosed. In one embodiment of the system, a remote server receives an installation quality assurance signal from a room within the hospitality establishment to ensure installation quality assurance of the room. Substantially contemporaneously, the server receives from a proximate wireless-enabled interactive programmable device located within the room, images of a unique identifier of the room, a unique identifier of the set-top box, and a physical connection between the set-top box and the display. These images are utilized to establish physical quality assurance of the room. The server may then render a map view of the hospitality establishment based on obtained map data. The map view including a graphical representation of the room annotated with at least one of the images.

### PRIORITY STATEMENT & CROSS-REFERENCE TO RELATED APPLICATIONS

This application claims priority from co-pending U.S. Patent Application No. 62/458,892, entitled “Entertainment Center Technical Configuration and System and Method for Use of Same”, filed on Feb. 14, 2017, in the names of William C. Fang et al.; which is hereby incorporated by reference for all purposes.

### TECHNICAL FIELD OF THE INVENTION

This invention relates, in general, to entertainment centers and, in particular, to entertainment center technical configurations concerning installation, maintenance, and repair configurations, for example, and systems and methods for use of the same that assist an operator with technical tasks.

### BACKGROUND OF THE INVENTION

Without limiting the scope of the present invention, the background will be described in relation to entertainment centers having televisions in the hospitality lodging industry, as an example. During hotel entertainment center installation processes, which includes television and set-top box installation, operators keep track of the progress and problems, if any, of the configuration manually. Such record keeping is difficult and prone to errors. Moreover, unresolved errors may result in multiple trips to the same location to completely troubleshoot a problem. As a result of limitations in existing technology, installation and configuration of televisions and set-top boxes is a frequent complaint and source of aggravation to installation operators and supervisors. Accordingly, there is a need for improved systems and methods for installing entertainment centers, including televisions and set-top boxes.

### SUMMARY OF THE INVENTION

It would be advantageous to introduce systems and methods that further the completion of technical tasks—and other installation, maintenance, and repair tasks—in hospitality lodging establishments and other transitory establishments to ensure completion of the tasks and reduce failure. It would also be desirable to enable a computer-based solution that would mitigate the dependency and issues with manually logged and manually verified installations, maintenance, and repair tasks. To better address one or more of these concerns, an entertainment center technical configuration and system and method for use of the same are disclosed. In one embodiment of the system, a remote server receives an installation quality assurance signal from a room within a hospitality establishment to ensure installation quality assurance of the room. Substantially contemporaneously, the server receives from a proximate wireless-enabled interactive programmable device located within the room, images of a unique identifier of the room, a unique identifier of the set-top box, and a physical connection between the set-top box and the display. These images are utilized to establish physical quality assurance of the room. The server may then render a map view of the hospitality establishment based on obtained map data. The map view including a graphical representation of the room annotated with at least one of the images. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing entertainment center technical configuration according to the teachings presented herein;

FIG. 2A is a schematic diagram depicting one embodiment of the system of FIG. 1 within an on-property deployment;

FIG. 2B is a schematic diagram depicting one embodiment of the system of FIG. 1 within a cloud-computing deployment;

FIG. 3A is a wall-facing exterior elevation view of one embodiment of the set-top box depicted in FIG. 1 in further detail;

FIG. 3B is a television-facing exterior elevation view of the set-top box depicted in FIG. 1;

FIG. 3C is a front perspective view of a dongle depicted in FIG. 1 in further detail;

FIG. 4 is a functional block diagram depicting one embodiment of the set-top box presented in FIGS. 3A and 3B;

FIG. 5 is a functional block diagram depicting one embodiment of the proximate wireless-enabled interactive programmable device presented in FIG. 1;

FIG. 6 is a functional block diagram depicting one embodiment of a server presented in FIGS. 2A and 2B;

FIG. 7 conceptual module diagram depicting the software architecture of an image viewing, editing, and organization application of some embodiments;

FIG. 8A is a schematic diagram depicting one embodiment of a digital representation of a hospitality lodging establishment with entertainment center technical configuration;

FIG. 8B is a schematic diagram depicting one embodiment of a digital representation of a floor of the hospitality lodging establishment presented in FIG. 8A;

FIG. 9 is a flow chart depicting one embodiment of a method for providing entertainment center technical configuration according to the teachings presented herein; and

FIG. 10 is a flow chart depicting another embodiment of a method for providing entertainment center technical configuration according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

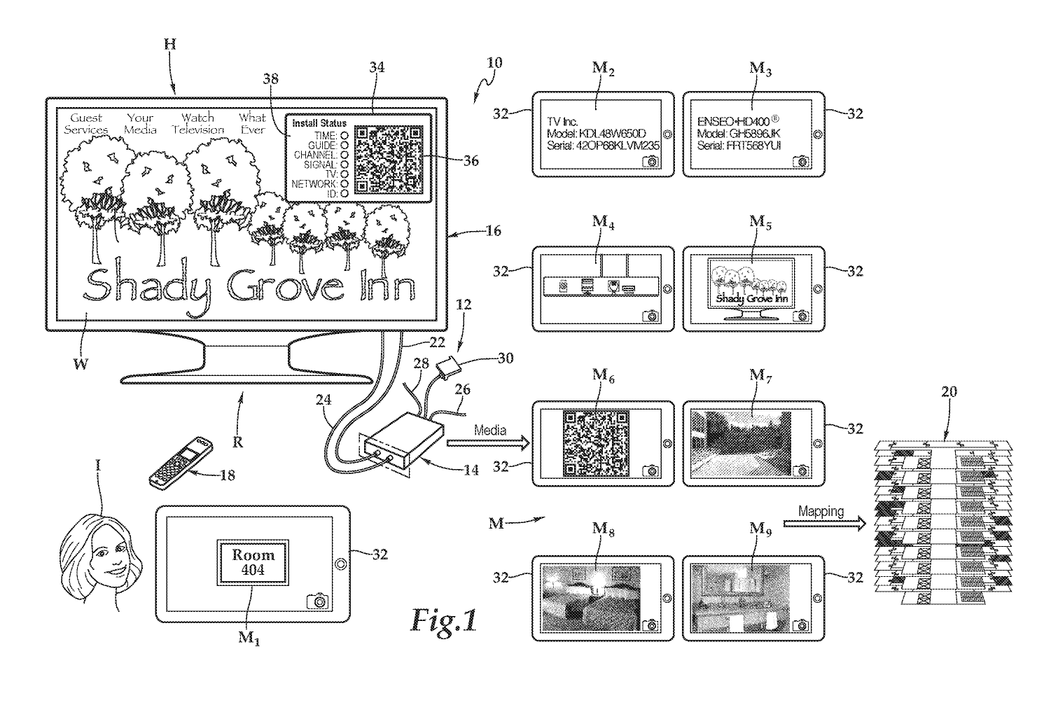

Referring initially to FIG. 1, therein is depicted one embodiment of a system 10 for providing entertainment center technical configuration with a hospitality lodging establishment to an entertainment center 12. The hospitality lodging establishment, which may be referred to as a hospitality property, may be a furnished multi-family residence, dormitory, lodging establishment, hotel, hospital, or other multi-unit environment. As shown, by way of example and not by way of limitation, the hospitality environment is depicted as a hotel H having various rooms, including room R, and spaces. The entertainment center 12 includes a set-top box 14, which is communicatively disposed with various amenities associated with the hospitality environment, including a display 16. As shown, the display 16 is depicted as a television. It should be appreciated however, that the display 16 may also be any electronic visual display device, for example. Entertainment centers, like the entertainment center 12, may be deployed throughout the rooms and spaces of the hotel H. The entertainment center 12 is depicted as including the set-top box 14, the display 16, and a remote control 18. It should be appreciated however that the entertainment center 12 may include any combination of electronic appliances, components, and devices and, in particular, any combination of electronic appliances, components, and devices found in the hospitality environment. As will be discussed in further detail hereinbelow, a map view 20 of the hospitality establishment H, including room R, may be rendered by the system 10 as part of and following the technical configuration of the entertainment center 12.

As shown, with respect to the set-top box 14 and the display 16, a connection, which is depicted as an HDMI connection 22, connects the set-top box 14 to the display 16. Other connections include a power cable 24 coupling the set-top box 14 to a power source, a coaxial cable 26 coupling the set-top box 14 to an external cable source, and a category five (Cat 5) cable 28 coupling the set-top box 14 to an external pay-per-view source at a hotel or other lodging establishment, for example. As shown, the set-top box 14 may include a dongle 30 providing particular technology and functionality extensions thereto. That is, the set-top box 14 may be a set-top box-dongle combination in one embodiment. More generally, it should be appreciated that the cabling connected to the set-top box 14 will depend on the environment and application, and the cabling connections presented in FIG. 1 are depicted for illustrative purposes. Further, it should be appreciated that the positioning of the set-top box 14 will vary depending on environment and application and, with certain functionality, the set-top box 14 may be placed more discretely behind the display 16. Moreover, it should be appreciated that the set-top box 14 and the display 16 may be at least partially or fully integrated.

The television remote control 18 includes an array of buttons for adjusting various settings such as television channel and volume and for providing various inputs during the installation, maintenance, or repair of the set-top boxes and the display 16, as discussed in more detail hereinbelow. In one embodiment, the television remote control 18 may be a consumer infrared (IR), Bluetooth or other wireless-protocol-based device configured as a small wireless handheld object that issues commands from a distance to the set-top box 14 in order to control the display 16 via the set-top box 14, for example.

A proximate wireless-enabled interactive programmable device 32 may be a device, including handheld devices, that may be supplied or carried by the guest and may be selected from a range of existing devices, such as, for example iPads®, iPhones®, iPod Touch®, Android® devices, Blackberry® devices, personal computers, laptops, tablet computers, smart phones, and smart watches, for example. As will be discussed in further detail hereinbelow, the proximate wireless-enabled interactive programmable device 32 is utilized by an installation technician I to execute an application providing a user interface guiding the installation technician I on the installation process.

In one operational embodiment, by way of an application, the proximate wireless-enabled interactive programmable device 32 provides step-by-step installation instructions to the installation technician I while prompting the installation technician I to use the camera and/or video functionality of the proximate wireless-enabled interactive programmable device 32 to document the work with images, pictures and/or video, for example, which is explained as media M. The installation technician I is prompted to take a picture of the door M₁ of the room at the beginning of the installation to provide for a physical quality check of the location of the installation technician I. In one embodiment, the proximate wireless-enabled interactive programmable device 32 then prompts the installation technician I to capture media M, which may be a photograph or video, for example, of the model and serial number of the display 16 as shown by media M₂. Similarly, the installation technician I is prompted to capture media M₃ of the model and serial number belonging to the set-top box 14. Following the establishment of physical connections between the components of the entertainment center 12, such as the set-top box 14 and the display 16, the installation technician I, following the instructions of the application on the proximate wireless-enabled interactive programmable device 32, captures media M₄ of the physical connections between the set-top box 14 and the display 16, for example.

The entertainment center 12 executes a technical protocol to make the various entertainment center 12 components, including the set-top box 14, the display 16, and the remote control 18 ready for use. The installation technician I captures media M₅ of the welcome screen W of the display as a physical quality check. In operation, in one embodiment, the set-top box 14 is able to automatically download software applications, upload software and update content packages, for example. Tracking and installation progress and reporting the trouble items may also be automated by using the hotel network and network connections beyond the hotel, including connections that interact with a cloud server such that information, including substantially real-time information, can be accessed by any members of the installation team and managers.

As the technical configuration, including the installation progresses, a technical status portal 34 may be shown on the display 16 and include a machine-readable optical label 36, which may be a Quick Response (QR) code, for example. The diagnostic and troubleshooting functions of the set-top box 14 also may generate the human-readable visual labels 38, which may correspond to the machine-readable optical label 36. Both may include specific diagnostic information about the technical protocol, which may relate to installation, maintenance, or repair, for example. The machine-readable optical label 36 may derived from a bitmask such as little Endian.

Both the machine-readable optical label 36 and the human-readable visual labels 38 may be continuously updated throughout the installation or maintenance or repair process in order to provide the installer or technician with a visual indication of the status and, when necessary, a machine-readable optical code which may be captured and shared via a mobile device, for example, with a remote system for verification or troubleshooting purposes. It should be appreciated that any number or configuration of technical status icons may be presented, including an entire screen of technical status icons or a scrolling feature allowing a defined space to provide many sheets of informative technical status icons. As shown, following the execution of the technical protocol by the set-top box 14, the application loaded on the proximate wireless-enabled interactive programmable device 32 or, alternatively, the application available via the Internet, for example, prompts the technical installer to capture media M₆ of the machine-readable optical label 36.

As presented herein, the same installation, maintenance, and repair information that is typically uploaded or transmitted through a network may be reported directly to the television screen for the technician to view and, optionally, capture via a mobile device as described in further detail hereinbelow. That is, as presented herein, in one embodiment, the set-top box may be considered as having a technical widget functionality that automates functions to be performed during installation, maintenance, and repair. Moreover, at the same time, the set-top box may self-perform various tests on critical aspects of the set-top box and television. The real-time reports which are generated may be transmitted through the hotels infrastructure or alternatively, captured on the television screen in the form of a machine-readable optical label, thereby creating a second, alternative or backchannel of communication for redundant communication during a technical task, such as installation, maintenance, or repair.

In one embodiment, following the application on the proximate wireless-enabled programmable device 32 guiding the installation technician I through the technical protocol to make the entertainment center 12 ready for use and establishing media relative to the physical quality check, the application on the proximate wireless-enabled programmable device 32 prompts the installation technician I to capture media relative to guest room spaces to establish the furnishing and amenities in the room. By way of example, the proximate wireless-enabled interactive programmable device 32 prompts the installation technician I to capture images of the view from the room, media M₇, the bed or beds in the room, media M₈, and the bathroom, media M₉. It should be appreciated that the teachings presented herein not only apply to installation but maintenance, repair, and other technical tasks as well. In some embodiments of the system 10, as part of various technical tasks, the media M₁ through M₉ are utilized to establish physical quality assurance of the room and a map view 20 of the hospitality establishment H may be rendered based on obtained map data. The map view may include a graphical representation of the room annotated with at least one instance of the media M₁ though M₉.

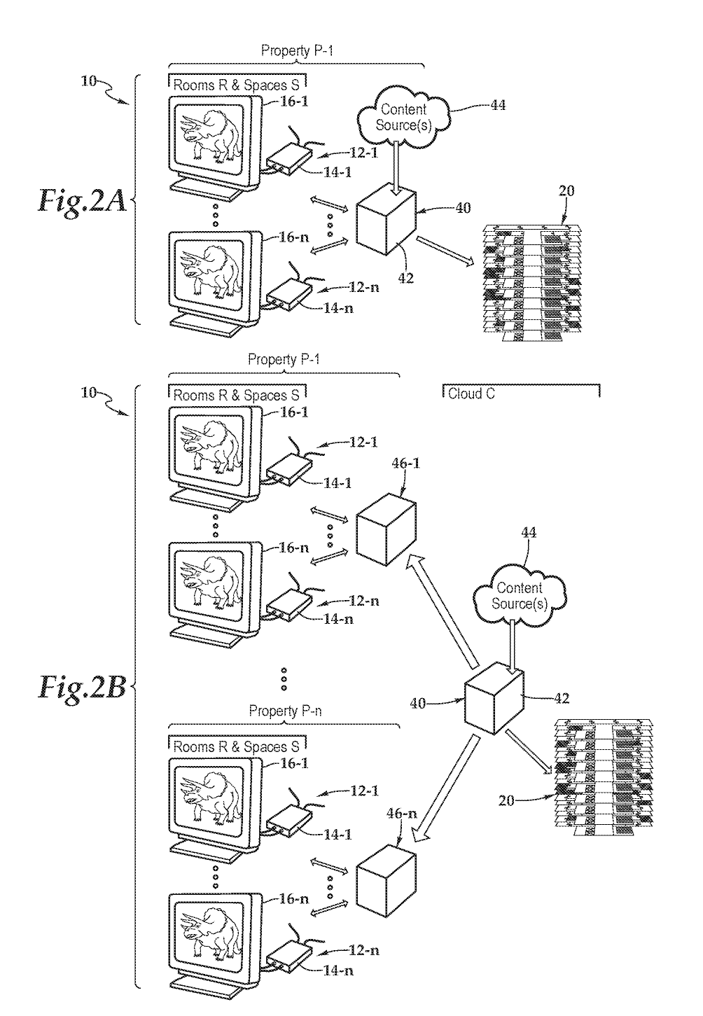

With reference to FIG. 2A and 2B, in one embodiment, the set-top box 14 sends an installation quality assurance signal relative to the execution of the technical protocol. A remote server 40 receives the installation quality assurance signal from the set-top box 14 and establishes installation quality assurance of the room based on the installation quality assurance signal. As mentioned, substantially contemporaneously with the execution of the technical protocol, the server 40 receives from the proximate wireless-enabled interactive programmable device 32 located within the room, images of a unique identifier of the room M₁, a unique identifier of the display M₂, a unique identifier of the set-top box M₃, a physical connection between the set-top box and the display M₄, the welcome screen on the display M₅, and the machine-readable optical label M₆. These images, media M₁ through M₆, are utilized to establish physical quality assurance of the room. Furthermore, substantially contemporaneously with the execution of the technical protocol, the server 40 receives from the proximate wireless-enabled interactive programmable device 32 located within the room, images of the view from the room, media M₇, the bed or beds in the room, media M₈, and the bathroom, media M₉. These images, media M₇through M₉, are utilized to remotely establish the furnishing and amenities in the room and create a virtual interactive experience with the room.

The server 40 may render a map view 20 of the hospitality establishment based on obtained map data. In some embodiments, the map view 20 may include a graphical representation of one or more rooms of the hospitality establishment that are annotated with data relative to the installation quality assurance, the physical quality assurance, or a combination thereof. More particularly, in some embodiments, the map view may include a graphical representation of one or more rooms of the hospitality establishment annotated with at least one instance of the media M₁ through M₉.

It should be appreciated that the server 40 may be located on a single property to serve one or more televisions thereon. Further, it should be appreciated that the server 40 may be remotely located to serve multiple properties having multiple televisions. Referring now to FIG. 2A, the system 10 may be deployed such that the server 40 is co-located on the property P-1 with the entertainment centers 12-1 . . . 12-n, with, in one embodiment, content sources 44 configured to provide sources of content. As shown, each of the entertainment centers 12-1 . . . 12-n may respectively include set-top boxes 14-1 . . . 14-n and displays 16-1 . . . 16-n. As shown, the server 40 includes a housing 42 having a television output and other components therein. The server 40 may render a map view 20 of the hospitality establishment that may be annotated as discussed herein.

Referring to FIG. 2B, the system 10 may be deployed such that the server 40, having the housing 42, is located remotely within cloud C relative to the entertainment centers 12-1 . . . 12-n, which are located at properties P-1 through P-n. As shown, each of the entertainment centers 12-1 . . . 12-n may respectively include set-top boxes 14-1 . . . 14-n and displays 16-1 . . . 16-n. In particular, the server 40, which receives content from content sources 44, may be located remotely relative to the entertainment centers 12-1 . . . 12-n such that a property headend 46-1 . . . 46-n is interposed between the server 40 and the entertainment centers 12-1 . . . 12-n. As shown, in this implementation, the property headend 46-1 . . . 46-n is co-located with the entertainment centers 12-1 . . . 12-n at a respective property, P-1 through P-n. The server 40 may render a map view 20 of the hospitality establishment that may be annotated as discussed herein.

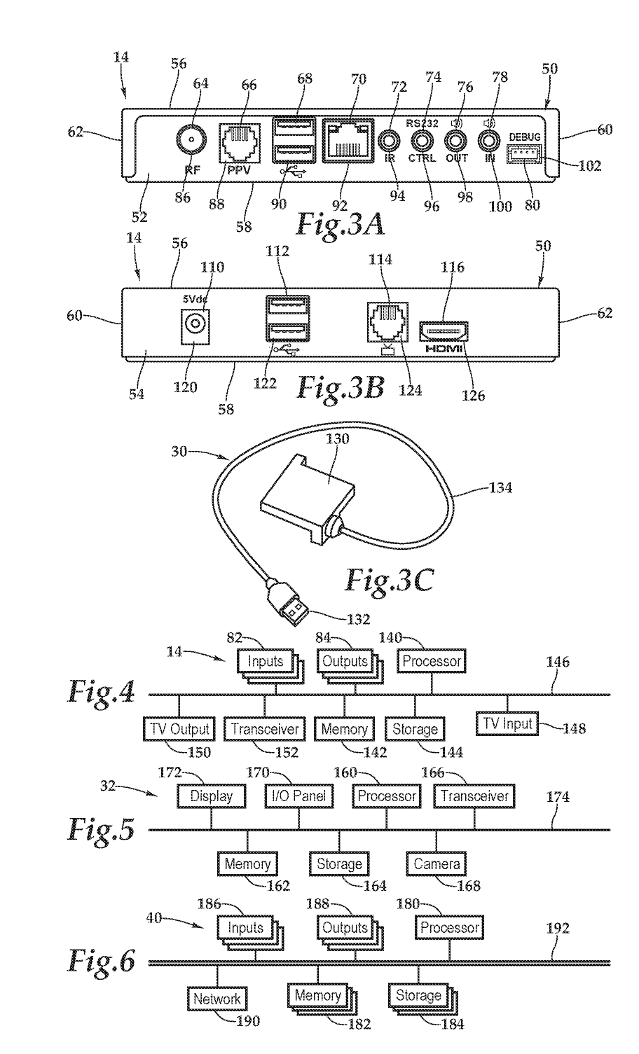

Referring to FIG. 3A, FIG. 3B, FIG. 3C, and FIG. 4, as used herein, set-top boxes, back boxes and set-top/back boxes may be discussed as set-top boxes. By way of example, the set-top box 14 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example.

The set-top box 14 includes a housing 50 having a rear wall 52, front wall 54, top wall 56, bottom base 58, and two sidewalls 60, 62. It should be appreciated that front wall, rear wall, and side wall are relative terms used for descriptive purposes and the orientation and the nomenclature of the walls may vary depending on application. The front wall includes various ports, ports 64, 66, 68, 70, 72, 74, 76, 78, and 80 that provide interfaces for various interfaces, including inputs and outputs. In one implementation, as illustrated, the ports 64 through 80 include inputs 82 and outputs 84 and, more particularly, an RF input 86, a RJ-45 input 88, universal serial bus (USB) input/outputs 90, an Ethernet category 5 (Cat 5) coupling 92, an internal reset 94, an RS232 control 96, an audio out 98, an audio in 100, and a debug/maintenance port 102. The front wall 54 also includes various inputs 82 and outputs 84. More particularly, ports 110, 112, 114, and 116 include a 5V dc power connection 120, USB inputs/outputs 122, an RJ-45 coupling 124, and an HDMI port 126. It should be appreciated that the configuration of ports may vary with the set-top box depending on application and context. As previously alluded to, the housing 50 may include a housing-dongle combination including, with respect to the dongle 30, a unit 130 having a cable 134 with a set-top box connector 132 for selectively coupling with the set-top box 14.

Within the housing 50, a processor 140, memory 142, storage 144, the inputs 82, and the outputs 84 are interconnected by a bus architecture 146 within a mounting architecture. It should be understood that the processor 140, memory 142, storage 144, the inputs 82, and the outputs 84 may be entirely contained within the housing 50 or the housing-dongle combination. The processor 140 may process instructions for execution within the computing device, including instructions stored in the memory 142 or in storage 144. The memory 142 stores information within the computing device. In one implementation, the memory 142 is a volatile memory unit or units. In another implementation, the memory 142 is a non-volatile memory unit or units. Storage 144 provides capacity that is capable of providing mass storage for the set-top box 14. Various inputs 82 and outputs 84 provide connections to and from the computing device, wherein the inputs 82 are the signals or data received by the set-top box 14, and the outputs 84 are the signals or data sent from the set-top box 14.

A television content signal input 148 and a television output 150 are also secured in the housing 50 in order to receive content from a source in the hospitality property and forward the content, including external content such as cable and satellite and pay-per-view (PPV) programing, to the television located within the hotel room.

A transceiver 152 is associated with the set-top box 14 and communicatively disposed with the bus 146. As shown the transceiver 152 may be internal, external, or a combination thereof to the housing. Further, the transceiver 152 may be a transmitter/receiver, receiver, or an antenna for example. Communication between various amenities in the hotel room and the set-top box 14 may be enabled by a variety of wireless methodologies employed by the transceiver 152, including 802.11, 3G, 4G, Edge, WiFi, ZigBee, near field communications (NFC), Bluetooth low energy and Bluetooth, for example. Also, infrared (IR) may be utilized.

The memory 142 and storage 144 are accessible to the processor 140 and include processor-executable instructions that, when executed, cause the processor 140 to execute a series of operations. The processor-executable instructions cause the processor to execute a technical protocol to make the set-top box and the display ready for use and then may cause the processor to send an installation quality assurance signal relative to the execution of the technical protocol. Also, the processor-executable instructions may include instructions to generate a human-readable visual label that contains information about the status of the technical protocol as well as generate a machine-readable optical label that contains information about the status of the technical protocol, the machine-readable optical label includes diagnostic information for escalated and remote trouble shooting about the status of the technical protocol. The processor-executable instructions may cause the processor to forward, via the television output, the output signal including the human-readable visual label and the machine-readable optical label to the television, and dynamically update the human-readable visual label and the machine-readable optical label as the status of the technical protocol changes.

Referring now to FIG. 5, the proximate wireless-enabled interactive programmable device 32 may be a wireless communication device of the type including various fixed, mobile, and/or portable devices. To expand rather than limit the previous discussion of the proximate wireless-enabled interactive programmable device 32, such devices may include, but are not limited to, cellular or mobile telephones, watches, two-way radios, personal digital assistants, digital music players, Global Position System units, and so forth. The proximate wireless-enabled interactive programmable device 32 may include a processor 160, memory 162, storage 164, transceiver 166, a camera 168, I/O panel 170, and a display 172 interconnected by a bus architecture 174. It should be appreciated that although a particular architecture is presented, other designs and layouts are within the teachings presented herein.

In one embodiment, the memory 162 and storage 164 are accessible to the processor 160 and include processor-executable instructions that, when executed, cause the processor 160 to execute a series of operations. The processor-executable instructions cause the processor to execute an application providing a user interface guiding the installation technician on the installation process. An installation procedure and diagrams may be displayed by the application one step at a time to guide the installation process. The application prompts the installation technician to use the camera and/or video to document the work-in-progress and completed with pictures and video at particular points in the process or step-by-step, for example.

Referring now to FIG. 6, one embodiment of the server 40 as a computing device includes a processor 180, memory 182, storage 184, inputs 186, outputs 188, and a network adaptor 190 interconnected with various buses 192 in a common or distributed, for example, mounting architecture. In other implementations, in the computing device, multiple processors and/or multiple buses may be used, as appropriate, along with multiple memories and types of memory. Further still, in other implementations, multiple computing devices may be provided and operations distributed therebetween. The processor 180 may process instructions for execution within the server 40, including instructions stored in the memory 182 or in storage 184. The memory 182 stores information within the computing device. In one implementation, the memory 182 is a volatile memory unit or units. In another implementation, the memory 182 is a non-volatile memory unit or units. Storage 184 includes capacity that is capable of providing mass storage for the server 40. Various inputs 186 and outputs 188 provide connections to and from the server 40, wherein the inputs 186 are the signals or data received by the server 40, and the outputs 188 are the signals or data sent from the server 40. The network adaptor 190 couples the server 40 to a network such that the server 40 may be part of a network of computers, a local area network (LAN), a wide area network (WAN), an intranet, a network of networks, or the Internet, for example.

The memory 182 and storage 184 are accessible to the processor 180 and include processor-executable instructions that, when executed, cause the processor 180 to execute a series of operations. In one embodiment, the processor-executable instructions cause the processor to receive the installation quality assurance signal from the set-top box prior to establishing installation quality assurance of the room based on the installation quality assurance signal. The processor-executable instructions also cause the processor to, substantially contemporaneously with the execution of the technical protocol to make the set-top box and the display ready for use, receive from a proximate wireless-enabled interactive programmable device located within the room one or more of the following: first media relative to an image of a unique identifier of the room; second media relative to a unique identifier of the set-top box; third media relative to a physical connection between the set-top box and the display; fourth media relative to a unique identifier of the display; fifth media relative to a welcome page on the display; sixth media relative to a machine-readable optical label that contains information about the status of the technical protocol; and seventh media relative to guest room spaces within the room.

The processor-executable instructions then cause the processor to establish physical quality assurance of the room based on the first, second, third, fourth, fifth, and sixth media. Further, in some embodiments, the processor-executable instructions cause the processor to establish furnishings and amenities in the room based on the seventh media. In some embodiments, the processor-executable instructions cause the processor to render a map view of the hospitality establishment based on obtained map data and the map view may include a graphical representation of the room and other rooms at the hospitality establishment. The processor-executable instructions, when executed, may cause the processor to render a 3-D perspective view of the hospitality establishment, a multi-floor view of the hospitality establishment, a 2-D top plan view of at least a portion the hospitality establishment, or a map view of a floor of the hospitality establishment, for example.

In some embodiments, the processor-executable instructions cause the processor to at least partially integrate or at least partially combine the at least one of the first, second, third, fourth, fifth, sixth, or seventh, media into the graphical representation of the room. The processor-executable instructions may include processor-executable instructions that, when executed, cause the processor to annotate the graphical representation of the room with data relative to the installation quality assurance or data relative to the physical quality assurance, for example. The processor-executable instructions may also include instructions that cause the processor to implement a map application configured to provide a user interface and obtain instructions from a user on the desired map view and annotations.

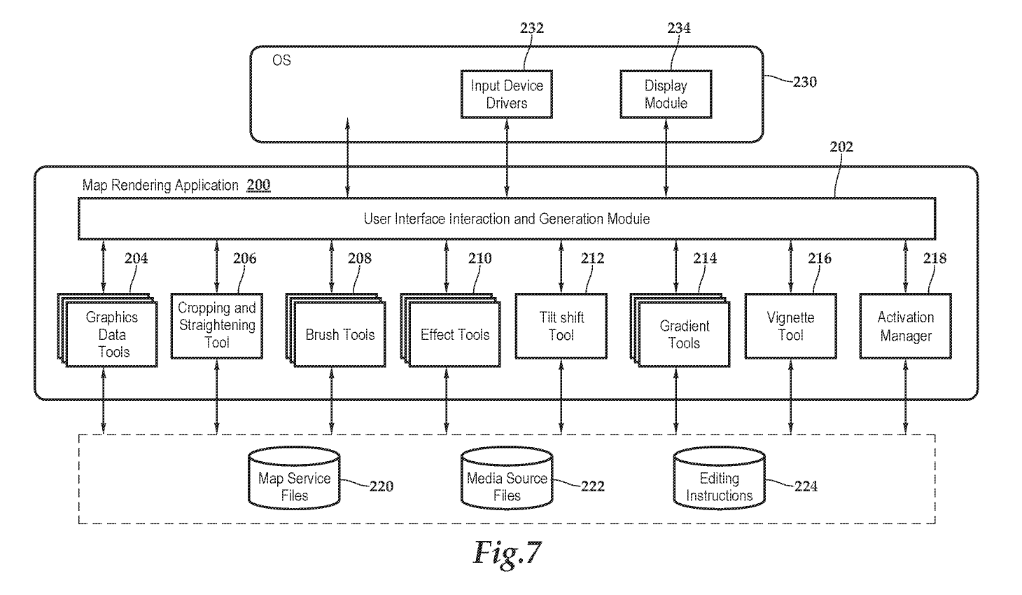

FIG. 7 conceptually illustrates the software architecture of a map rendering application 200 of some embodiments that may render the map view 20 of the hospitality establishment H. In some embodiments, the map rendering application 200 is a stand-alone application or is integrated into another application, while in other embodiments the application might be implemented within an operating system. Furthermore, in some embodiments, the map rendering application 200 is provided as part of a server-based solution or a cloud-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The map rendering application 200 includes a user interface (UI) interaction and generation module 202, a graphics data tools 204, a cropping and straightening tool 206, brush tools 208, effect tools 210, a tilt shift tool 212, a gradient tool 214, a vignette tool 216, and an activation manager 218. The image editing application has access to map service files 220, media source files 222, and editing instructions 224. In some embodiments, the map service files may be vector graphics data files with texture identifiers or two or three dimensional map image files specified in one or more map tiles that may be raster-based map tiles, for example.

The media source files 222 store the media content (e.g. text, audio, image, and video content), such as media M₁ through M₉, which may be photographs, images, video files, audio-video files, panoramic photographs, or spherical photographs, for example. The editing instructions 224 store the image editing operations that the map rendering application 200 performed as a set of instructions. The map rendering application 200 uses these set of instructions to generate new images based on the original data stored in the source files. In some embodiments, the map image files and/or media content data are stored as .mov, .avi, .jpg, .png, .gif, pdf, .mp3, .bmp, .wav, .txt, .tiff, etc. files in the map service files 220 and media source files 222. In some embodiments, storages 220, 222, and 224 are all stored in one physical storage. In other embodiments, the storages 220, 222, 224 are in separate physical storages, or one of the storages is in one physical storage while the other is in a different physical storage. For instance, the other project data and the source files will often be separated.

In the illustrated embodiment, FIG. 7 also includes an operating system 230 that includes input device driver(s) 232 and a display module 234. In some embodiments, as illustrated, the device drivers 232 and display module 234 are part of the operating system 230 even when the image editing application is an application separate from the operating system. The input device drivers 232 may include drivers for translating signals from a keyboard, mouse, touchpad, tablet, touch screen, gyroscope, accelerometer, etc. A user interacts with one or more of these input devices, which send signals to their corresponding device driver. The device driver then translates the signals into user input data that is provided to the UI interaction module 202.

The present application describes a graphical user interface that provides users with numerous ways to perform different sets of operations and functionalities. By either executing a pre-determined series of editing instructions on a pre-determined set of media source files or receiving a selection of media processing operations, the present map rendering application 200 provides for a map view of the hospitality establishment with the appropriate annotations.

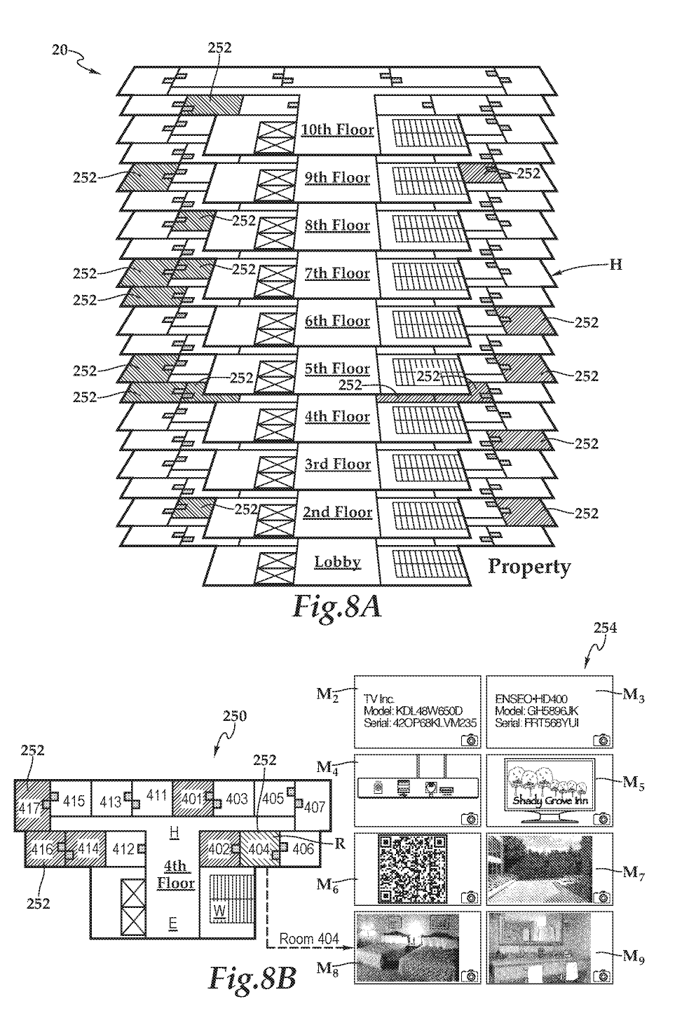

Referring now to FIG. 8A and FIG. 8B, in one implementation, property monitoring and optimization is provided in the form of a database, or as shown, in the map view 20 of the hospitality establishment H including a graphical presentation 250 of a floor of the hospitality establishment H, wherein particular hotel rooms with technical configuration data in substantially real time permits a user or manager to select the desired information and make optimal technical configuration decisions. In particular, color-coding and hue assignment adds additional understanding and visibility into housekeeping and maintenance conditions as well as use. By way of example and not by way of limitation, the hospitality establishment is graphical depicted as having a lobby and ten floors, which are lobby, 2^{nd} floor, 3rd floor, etc. For each floor, such as the 4^{th} floor, a floor layout is shown with rooms, such as rooms 401 through 407 and 411 through 417. In FIGS. 8A and 8B, by collecting the substantially real time technical configuration information from the field, a map may be shown depicting all rooms with an outstanding technical configuration status 252, for example. In particular, room 404 from FIG. 1 is highlighted to inspect the technical configuration, including the installation quality assurance and the physical quality assurance. With this information and knowledge of the issue, technical support may appropriately prioritize the requests, handle the requests in an optimal order, and bring all needed equipment. As mentioned, it should be appreciated that other types of databases and charts may be prepared from the substantially real-time information collected. As shown, by way of example, the progress of the technical configuration of Room 404 is being examined wherein the graphical representation of room 404 is annotated with media M₂ through M₉. That is, in some embodiments, once the media or, more specifically, pictures are taken, the pictures are directly uploaded to the server and a database and then associated with the rooms shown on the map view. The installation managers and project managers use the map view to gather real time information about the installation progress and reports on the functional failures from the installation. With the pictures uploaded, the installation managers and project managers are also able to exam the installation workmanship in completed rooms. To view the pictures taken from each room, the map view users can select a room from the map and appropriately click or tap on the rooms and then select the room photos or other image processing operations requested.

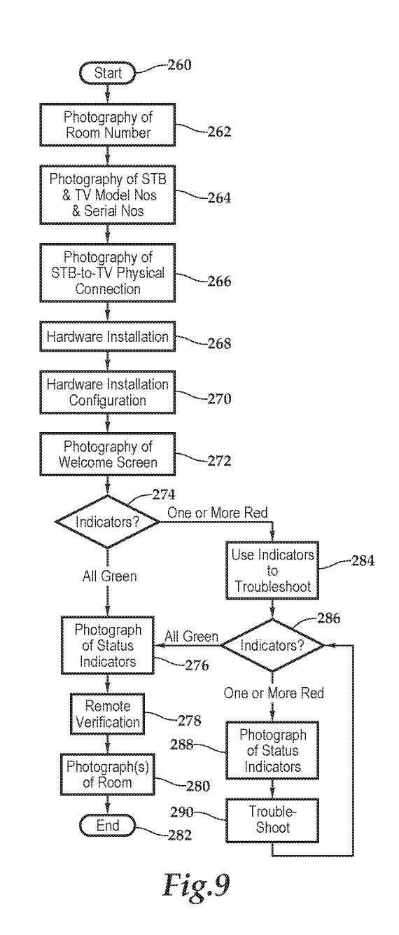

Referring now to FIG. 9, one embodiment of a method utilizing entertainment centers and particularly set-top boxes with installation, as an example, within the hospitality lodging industry is depicted. It should be appreciated that the methodology presented herein is also applicable to maintenance and repair as well. At block 260, the methodology is initiated and advanced to block 262 where a photograph of the room number on the door, for example is taken by an installer to remotely establish physical quality assurance. The photograph is forwarded to the remote server. In one implementation, the installation and data collected during the installation is associated with the installer and the quality of the work performed by the installer and the efficiency of the installer, such as time required to install each room and the number of rooms installed per day, may be collected, evaluated, and graphed. At block 264, the model and serial numbers of the components of the entertainment center, including the set-top box and the display, are photographed and the photograph is forwarded to the remote server. At block 266, following the installation technician completing the physical connections within the entertainment center, photographs of the physical connections are captured and the photographs are forwarded to the remote server. At block 268, the hardware installation begins with the various connections of the set-top box and television being completed. At block 270, the installation technician initializes the installation configuration of the set-top box by, in one embodiment, actuating a code on a remote control associated with the set-top box. At block 272, the installation technician is prompted to capture a photograph of a welcome screen on the display to further the remote establishment of physical quality assurance. The photograph is forwarded to the remote server. At decision block 274, as the installation process progresses, the installer views the television screen for the visual indicators, which, in one implementation, light green or red to show progress on several installation protocol items.

If the visual indicator lights are all green, then the methodology advances to block 276, where the installer captures a photograph or image of the machine-readable optical label and forwards the same at block 278 to a verification system, which may be a property server on-site or alternatively, a property management or maintenance server off-site. It should be appreciated that other forms of verification, including communication between any on-site property server or an off-site property management server may also occur with the set-top box as part of the installation process. The transmission of the machine-readable optical code by an alternative route, i.e., mobile device backchannel provides additional verification. At block 280, the technician is prompted to capture images of the room to establish the amenities and views therein. At block 282, the methodology ends.

Returning to decision block 274, if one or more indicators are red, then the methodology advances to block 284 where the installer uses the indicators to trouble shoot or diagnose the problem. As previously discussed, the indicators may include a QR code, for example, that may be read to provide additional details on the testing, such as functional test results and selftest results. Further, at the block 274, troubleshooting tips may be provided if there are issues. At decision block 286, if following diagnostic action, the indicators are all green, then the flow chart advances to previously discussed block 276. On the other hand, if one or more indicators are still red, then an image or photograph of the machine-readable optical label is captured at block 288 and transmitted at block 290 to provide escalated and remote trouble shooting. As previously discussed, the machine-readable optical label provides diagnostic information, which can be read at the remote location to provide insight into the nature of the problem. Moreover, often during installation and maintenance when issues occur, the set-top box under work may not be in communication with the remote site. Therefore, the methodology presented herein provides an alternative channel of communication of data relevant to the installation issue. Following block 290, the methodology returns to decision block 286.

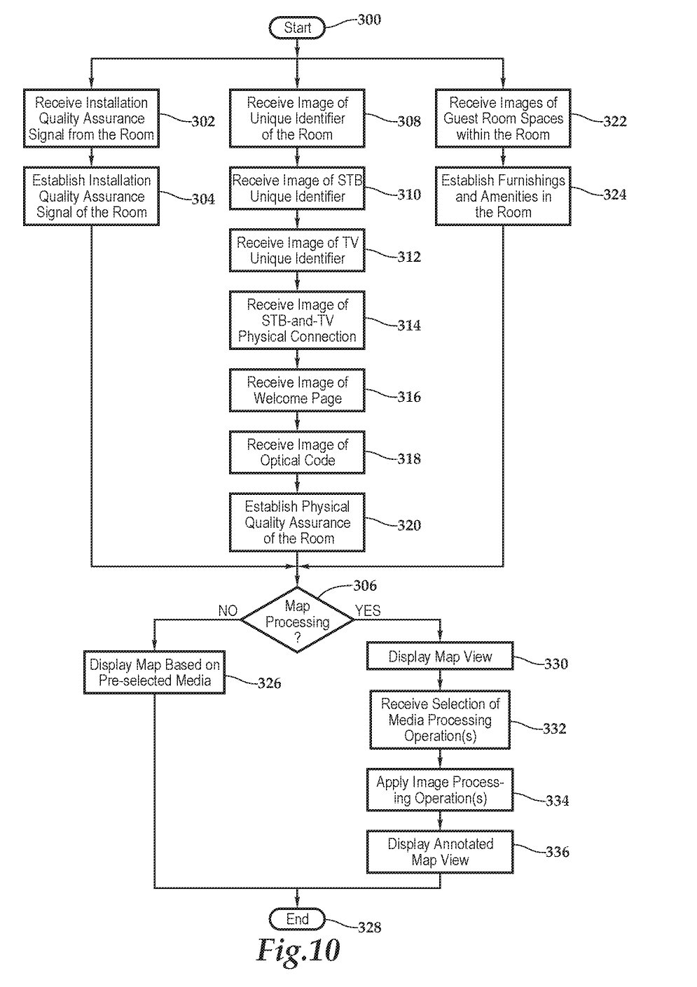

Referring now to FIG. 10, another embodiment of a method for providing entertainment center technical configuration is presented. At block 300, the methodology is initiated and advanced to block 302 where the server receives an installation quality assurance signal from the room via the installer technician and the proximate wireless-enabled interactive programmable device. The installation quality assurance may include, by way of example, at least one task including verifying the room is online; verifying the room has passed a self-test; verifying the room is free of TV connection issues, HDMI connection issues, and TV control connection issues; verifying that the set-top box satisfies RF specifications; verifying that Bluetooth® devices are activated, verifying WiFi devices are activated, and verifying room number match. At block 304, prior to advancing to map processing decision block 306, the server utilizes the installation quality assurance signal to establish installation quality assurance in the room. Substantially contemporaneously with the execution of blocks 302 and 304, at block 308, the server receives media, which may be a photograph or video, for example, of a unique identifier, such as a room number on a door, of the room. At blocks 310, 312, 314, 316, and 318, the server respectively receives media relative to a unique identifier of the set-top box, media relative to a unique identifier of the display, media relative to the physical connection between the set-top-box and the display, media relative to a welcome page on the display, and an image of a machine-readable optical label from the display, for example. At block 320, the server utilizes the media captured during blocks 310 through 318 to remotely establish physical quality assurance of the room. At block 306, the methodology advances to the map processing decision block.

In some embodiments, substantially contemporaneously with the execution of blocks 302 and 304 as well as blocks 308 through 320, at block 322, the server receives media relative to guest room spaces within the room. By way of example and not by way of limitation, the media relative to guest room spaces within the room may include audiovisual media such as bathroom area audiovisual media, dressing area audiovisual media, clothes storage area audiovisual media, sleeping area audiovisual media, work area audiovisual media, entry area audiovisual media, window view audiovisual media, and hallway area audiovisual media. At block 324, the server utilizes the media received at block 322 to establish the furnishing and amenities in the room to create a virtual experience and virtual documentation of the room. The methodology then advances to decision block 306.

At decision block 306, if the map processing including any applied annotations are based on a pre-selected or pre-stored or pre-defined criteria, then the methodology advances to block 326 where the appropriate map view is rendered prior to at block 328, the methodology ending. On the other hand, at decision block 306, if user input will be sought on the map view and annotations then the methodology displays the map view at block 330. Then at block 332, the server receives selection of media processing operations from the user and then applies the image processing operations at block 334. The media processing operations may include, for example, selecting the media to be displayed and various luminance and color properties and such to provide further visibility into the map view. At block 336, the map view with annotations is rendered prior to the methodology ending at block 328.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for entertainment center technical configuration, the system comprising:
a set-top box located in a room at a hospitality establishment having a plurality of rooms, the set-top box including:
a housing securing a television input, a television output, a processor, memory, and storage therein,
a busing architecture communicatively interconnecting the television input, the television output, the processor, the memory, and the storage,
the television input configured to receive a source signal from an external source,
the television output configured to forward a fully tuned signal to a display, and
the memory accessible to the processor, the memory including processor-executable instructions that, when executed, cause the processor to:
execute a technical protocol to make the set-top box and the display ready for use,
send an installation quality assurance signal relative to the execution of the technical protocol; and
a server located remote to the room, the server including:
a housing securing inputs, outputs, a processor, memory, and storage therein,
a busing architecture communicatively interconnecting the inputs, outputs, the processor, the memory, and the storage, and
the memory accessible to the processor, the memory including processor-executable instructions that, when executed, cause the processor to:
receive the installation quality assurance signal from the set-top box,
establish installation quality assurance of the room based on the installation quality assurance signal,
substantially contemporaneously with the execution of the technical protocol to make the set-top box and the display ready for use, receive from a proximate wireless-enabled interactive programmable device located within the room, first media relative to an image of a unique identifier of the room, second media relative to a unique identifier of the set-top box, and third media relative to a physical connection between the set-top box and the display,
establish physical quality assurance of the room based on the first, second, and third media,
rendering a map view of the hospitality establishment based on obtained map data, the map view including a graphical representation of the room and a plurality of other rooms at the hospitality establishment, and
annotating the graphical representation of the room with at least one of the first, second, and third media.

2. The system as recited in claim 1, wherein the hospitality establishment is selected from the group consisting of furnished multi-family residences, dormitories, lodging establishments, hotels, hospitals, and multi-unit environments.

3. The system as recited in claim 1, wherein the processor-executable instructions of the server further comprise processor-executable instructions that, when executed, cause the processor to render a 3-D perspective view of the hospitality establishment.

4. The system as recited in claim 1, wherein the processor-executable instructions of the server further comprise processor-executable instructions that, when executed, cause the processor to render a multi-floor view of the hospitality establishment.

5. The system as recited in claim 1, wherein the processor-executable instructions of the server further comprise processor-executable instructions that, when executed, cause the processor to render a 2-D top plan view of at least a portion the hospitality establishment.

6. The system as recited in claim 1, wherein the processor-executable instructions of the server further comprise processor-executable instructions that, when executed, cause the processor to render a map view of a floor of the hospitality establishment.

7. The system as recited in claim 1, wherein the processor-executable instructions of the server further comprise processor-executable instructions that, when executed, cause the processor to least partially integrate the at least one of the first, second, and third media into the graphical representation of the room.

8. The system as recited in claim 1, wherein the processor-executable instructions of the server further comprise processor-executable instructions that, when executed, cause the processor to at least partially combine the at least one of the first, second, and third media with the graphical representation of the room.

9. The system as recited in claim 1, wherein the processor-executable instructions of the server further comprise processor-executable instructions that, when executed, cause the processor to annotate the graphical representation of the room with data relative to the installation quality assurance.

10. The system as recited in claim 1, wherein the processor-executable instructions of the server further comprise processor-executable instructions that, when executed, cause the processor to annotate the graphical representation of the room with data relative to the physical quality assurance.

11. The set-top box as recited in claim 1, wherein the proximate wireless-enabled interactive programmable device comprises a device selected from the group consisting of personal computers, laptops, tablet computers, smart phones, and smart watches.

12. The system as recited in claim 1, wherein the installation quality assurance further comprises at least one task selected from the group consisting of verifying the room is online; verifying the room has passed a self-test; verifying the room is free of TV connection issues, HDMI connection issues, and TV control connection issues; verifying that the set-top box satisfies RF specifications; verifying that Bluetooth® devices are activated, verifying WiFi devices are activated, and verifying room number match.

13. The system as recited in claim 1, wherein the first media further comprises an image of a room number on a door of the room.

14. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive fourth media relative to a unique identifier of the display.

15. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive fifth media relative to a welcome page on the display.

16. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive sixth media relative to a machine-readable optical label that contains information about the status of the technical protocol.

17. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive seventh media relative to guest room spaces within the room.

18. The system as recited in claim 17, wherein the seventh media relative to guest room spaces within the room further comprises audiovisual media of the room selected from the group consisting of bathroom area audiovisual media, dressing area audiovisual media, clothes storage area audiovisual media, sleeping area audiovisual media, work area audiovisual media, entry area audiovisual media, window view audiovisual media, and hallway area audiovisual media.

19. A system for entertainment center technical configuration, the system comprising:
a set-top box located in a room at a hospitality establishment having a plurality of rooms, the set-top box including:
a housing securing a television input, a television output, a processor, memory, and storage therein,
a busing architecture communicatively interconnecting the television input, the television output, the processor, the memory, and the storage,
the television input configured to receive a source signal from an external source,
the television output configured to forward a fully tuned signal to a display, and
the memory accessible to the processor, the memory including processor-executable instructions that, when executed, cause the processor to:
execute a technical protocol to make the set-top box and the display ready for use,
send an installation quality assurance signal relative to the execution of the technical protocol, generate a human-readable visual label that contains information about the status of the technical protocol;
generate a machine-readable optical label that contains information about the status of the technical protocol, the machine-readable optical label includes diagnostic information for escalated and remote trouble shooting about the status of the technical protocol,
forward, via the television output, the output signal including the human-readable visual label and the machine-readable optical label to the television, and
dynamically update the human-readable visual label and the machine-readable optical label as the status of the technical protocol changes; and
a server located remote to the room, the server including:
a housing securing inputs, outputs, a processor, memory, and storage therein,
a busing architecture communicatively interconnecting the inputs, outputs, the processor, the memory, and the storage, and
the memory accessible to the processor, the memory including processor-executable instructions that, when executed, cause the processor to:
receive the installation quality assurance signal from the set-top box,
establish installation quality assurance of the room based on the installation quality assurance signal,
substantially contemporaneously with the execution of the technical protocol to make the set-top box and the display ready for use, receive from a proximate wireless-enabled interactive programmable device located within the room, first media relative to an image of a unique identifier of the room, second media relative to a unique identifier of the set-top box, and third media relative to a physical connection between the set-top box and the display, receive fourth media relative to a unique identifier of the display, receive fifth media relative to a welcome page on the display, and sixth media relative to a machine-readable optical label that contains information about the status of the technical protocol,
establish physical quality assurance of the room based on the first, second, third, fourth, fifth, and sixth media,
rendering a map view of the hospitality establishment based on obtained map data, the map view including a graphical representation of the room and a plurality of other rooms at the hospitality establishment, and
annotating the graphical representation of the room with at least one of the first, second, third, fourth, fifth, and sixth media.

20. A system for entertainment center technical configuration, the system comprising:
a set-top box located in a room at a hospitality establishment having a plurality of rooms, the set-top box including:
a housing securing a television input, a television output, a processor, memory, and storage therein,
a busing architecture communicatively interconnecting the television input, the television output, the processor, the memory, and the storage,
the television input configured to receive a source signal from an external source,
the television output configured to forward a fully tuned signal to a display, and
the memory accessible to the processor, the memory including processor-executable instructions that, when executed, cause the processor to:
execute a technical protocol to make the set-top box and the display ready for use,
send an installation quality assurance signal relative to the execution of the technical protocol, generate a human-readable visual label that contains information about the status of the technical protocol;
generate a machine-readable optical label that contains information about the status of the technical protocol, the machine-readable optical label includes diagnostic information for escalated and remote trouble shooting about the status of the technical protocol,
forward, via the television output, the output signal including the human-readable visual label and the machine-readable optical label to the television, and
dynamically update the human-readable visual label and the machine-readable optical label as the status of the technical protocol changes; and
a server located remote to the room, the server including:
a housing securing inputs, outputs, a processor, memory, and storage therein,
a busing architecture communicatively interconnecting the inputs, outputs, the processor, the memory, and the storage, and
the memory accessible to the processor, the memory including processor-executable instructions that, when executed, cause the processor to:
receive the installation quality assurance signal from the set-top box,
establish installation quality assurance of the room based on the installation quality assurance signal,
substantially contemporaneously with the execution of the technical protocol to make the set-top box and the display ready for use, receive from a proximate wireless-enabled interactive programmable device located within the room, first media relative to an image of a unique identifier of the room, second media relative to a unique identifier of the set-top box, and third media relative to a physical connection between the set-top box and the display, receive fourth media relative to a unique identifier of the display, receive fifth media relative to a welcome page on the display, sixth media relative to a machine-readable optical label that contains information about the status of the technical protocol, receive seventh media relative to guest room spaces within the room,
establish physical quality assurance of the room based on the first, second, third, fourth, fifth, and sixth media,
establish furnishings and amenities in the room based on the seventh media,
rendering a map view of the hospitality establishment based on obtained map data, the map view including a graphical representation of the room and a plurality of other rooms at the hospitality establishment, and
annotating the graphical representation of the room with at least one of the first, second, third, fourth, fifth, and sixth media.
